(19) United States
(12) Patent Application Publication
(10) Pub. No.: US 2023/0305836 A1
(43) Pub. Date: Sep. 28, 2023

(54) TRIPLE-BAND TRIGGER TOOL FOR TIRE-PRESSURE MONITORING SYSTEM

(71) Applicant: Chia-Wen Cheng, TAIPEI CITY (TW)

(72) Inventor: Chia-Wen Cheng, TAIPEI CITY (TW)

(21) Appl. No.: 18/203,069

(22) Filed: May 30, 2023

Related U.S. Application Data
(63) Continuation-in-part of application No. 17/351,246, filed on Jun. 18, 2021.

(51) Int. Cl. G06F 8/654; G01L 17/00; H04L 67/00

(52) U.S. Cl. CPC G06F 8/654; G01L 17/00; H04L 67/34; H04B 1/40

(57) ABSTRACT

A triple-band trigger tool for a tire-pressure monitoring system is disclosed. The tool body includes a 315 MHz transceiver circuit and a 315 MHz antenna electrically connected to each other, and the 315 MHz transceiver circuit is electrically connected to a control unit; the tool body also includes a 433 MHz transceiver circuit and a 433 MHz antenna electrically connected to each other, and the 433 MHz transceiver circuit is electrically connected to the control unit; the tool body also includes a Bluetooth transceiver circuit and a Bluetooth antenna electrically connected to each other, and the Bluetooth transceiver circuit is electrically connected to the control unit. Therefore, the triple-band trigger is able to perform a firmware programming operation on a TPMS sensor at 315 MHz, 434 MHz or Bluetooth frequency band.

### CROSS-REFERENCE TO RELATED APPLICATIONS

This application is a Continuation-in-Part of application Ser. No. 17/351,246, filed on Jun. 18, 2021, and entitles TRIPLE-BAND TRIGGER TOOL FOR TIRE-PRESSURE MONITORING SYSTEM.

### BACKGROUND OF THE INVENTION

### 1. Field of the Invention

The present invention is related to a tool applied to a tire-pressure monitoring system (TPMS), and more particularly to a tool which has three frequency bands including 315 MHz, 434 MHz and Bluetooth frequency band and is applicable to a TPMS sensor with at least one of communication protocols of three frequency bands including 315 MHz, 434 MHz and Bluetooth frequency band.

### 2. Description of the Related Art

A tire-pressure monitoring system (TPMS) sensor installed in a tire is developed to be a smaller size in considerations of installation and weight. Furthermore, in consideration of the waterproof performance and most reliability issues, most of the TPMS sensors are designed with one-time batteries, and once the power of one-time battery is exhausted, the original TPMS sensor cannot be reused by just replacing the battery, and a new TPMS is required to replace the original TPMS sensor. In addition, among methods of extending the service life of the battery in the TPMS sensor, the most effective method is to make the TPMS sensor enter a sleep mode and stop sending tire pressure data while the vehicle is stopped, and the operational mode of the TPMS sensor can be switched from the sleep mode to a traveling mode to periodically transmit tire temperature and tire pressure data only after the vehicle is running at a certain speed. Another method is to install a low-frequency 125 KHz wake-up circuit inside the TPMS sensor and use a TPMS dedicated tool to send a 125 KHz signal to wake up the TPMS sensor, so that the TPMS sensor can send the tire temperature, tire pressure or other information at 315 MHz/434 MHz or Bluetooth frequency band after being woken up; after the car manufacturer installs the TPMS sensor in the tire or a vehicle repair shop replaces the TPMS sensor, the vehicle can be inspected by the dedicated tool before delivery.

Currently, the TPMS wake-up or programming tools available on the market are mainly for the above-mentioned 315 MHz and 434 MHz bands, but there are few TPMS dedicated tools for Bluetooth TPMS sensor on the market, so the aforementioned automobile manufacturers or repair shop must further purchase the TPMS dedicated tools for Bluetooth frequency band, in addition to the common TPMS dedicated tools for the 315 MHz and 434 MHz bands. Therefore, what is needed is to solve the conventional problem of tool compatibility and cost expenditure in the industry.

### SUMMARY OF THE INVENTION

An objective of the present invention is to provide a triple-band trigger tool for three frequency bands including 315 MHz, 434 MHz and Bluetooth frequency band, so that the triple-band trigger tool is able to perform a firmware programming function on a TPMS sensor for Bluetooth frequency band, besides on the conventional TPMS sensors for 315 MHz and 434 MHz bands.

In order to achieve the aforementioned objective and effect, the present invention provides a triple-band trigger tool for a tire-pressure monitoring system, and the triple-band trigger tool includes a tool body. The tool body includes a battery, a memory, a control unit, an input unit and a display unit. Each of the battery, the memory, the input unit, and the display unit is electrically connected to the control unit. The tool body also includes a 315 MHz transceiver circuit, a 315 MHz antenna, a 433 MHz transceiver circuit, a 433 MHz antenna, a Bluetooth transceiver circuit and a Bluetooth antenna, the 315 MHz transceiver circuit and the 315 MHz antenna are electrically connected to each other, the 315 MHz transceiver circuit is electrically connected to the control unit, the 433 MHz transceiver circuit and the 433 MHz antenna are electrically connected to each other, the 433 MHz transceiver circuit is electrically connected to the control unit, the Bluetooth transceiver circuit and the Bluetooth antenna are electrically connected to each other, and the Bluetooth transceiver circuit is electrically connected to the control unit.

### BRIEF DESCRIPTION OF THE DRAWINGS

The structure, operating principle and effects of the present invention will be described in detail by way of various embodiments which are illustrated in the accompanying drawings.

FIG. 1 is a perspective view of a triple-band trigger tool of the present invention.

FIG. 2 is a schematic circuit block view of a triple-band trigger tool of the present invention.

FIG. 3 is a schematic view showing that a triple-band trigger tool of the present invention performs automatic scanning determination on a TPMS sensor.

FIG. 4 is a schematic view showing that a triple-band trigger tool displays an automatic scanning determination indicative of Bluetooth frequency band, according to the present invention.

FIG. 5 is a schematic view showing that a triple-band trigger tool performs a firmware programming function on a TPMS sensor in a Bluetooth frequency band, according to the present invention.

FIG. 6 is a schematic view showing that a triple-band trigger tool displays completion of programming operation and displays a temperature value and a pressure value sensed by a TPMS sensor, according to the present invention.

FIG. 7 is a schematic circuit block view of another embodiment of a triple-band trigger tool of the present invention.

FIG. 8 is a schematic view showing that the firmware program is wirelessly transmitted from an external tool and stored in the temporary storage area.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

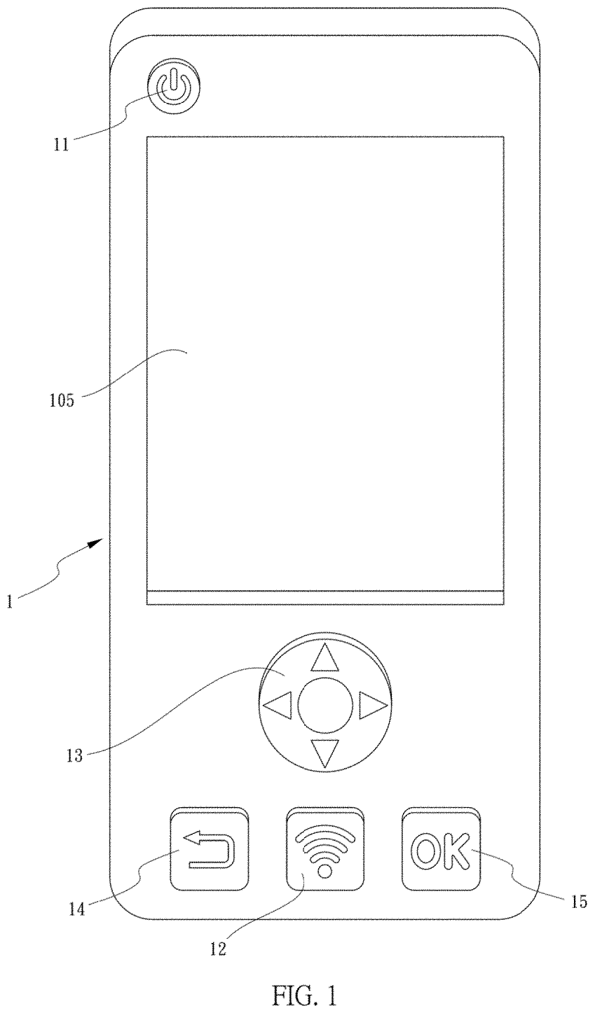

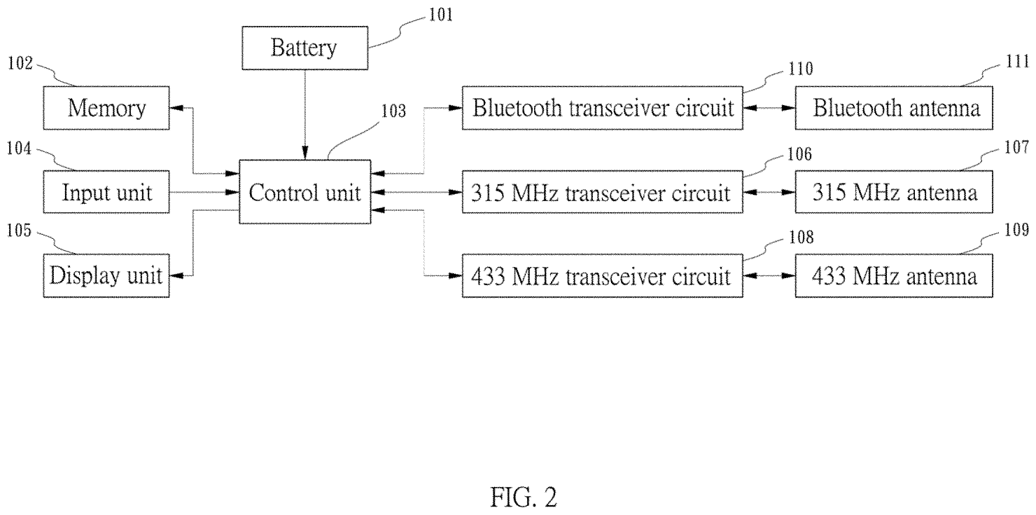

Please refer to FIGS. 1 and 2. As shown in FIGS. 1 and 2, a triple-band trigger tool for a tire-pressure monitoring system includes a tool body 1, and the tool body 1 includes a battery 101, a memory 102, a control unit 103, an input unit 104 and a display unit 105. Each of the battery 101, the memory 102, the input unit 104 and the display unit 105 is electrically connected to the control unit 103. The tool body 1 further includes a 315 MHz transceiver circuit 106 and a 315 MHz antenna 107 electrically connected to each other, and the 315 MHz transceiver circuit 106 is electrically connected to the control unit 103. The tool body 1 further includes a 433 MHz transceiver circuit 108 and a 433 MHz antenna 109 electrically connected to each other, and the 433 MHz transceiver circuit 108 is electrically connected to the control unit 103. The tool body 1 further includes a Bluetooth transceiver circuit 110 and a Bluetooth antenna 111 electrically connected to each other, and the Bluetooth transceiver circuit 110 is electrically connected to the control unit 103.

In the triple-band trigger tool of the present invention, the 315 MHz transceiver circuit 106 and the 315 MHz antenna 107, the 433 MHz transceiver circuit 108 and the 433 MHz antenna 109 of the tool body 1 can be used to perform a firmware programming function on a TPMS sensor 200 (for 315 MHz or 433 MHz band) at 315 MHz or 433 MHz band; furthermore, the triple-band trigger tool of the present invention can also perform the firmware programming operation on the TPMS sensor 200 (for Bluetooth frequency band) through the Bluetooth transceiver circuit 110 and Bluetooth frequency band of the Bluetooth antenna 111. Therefore, the triple-band trigger tool of the present invention is indeed able to program firmware into the TPMS sensor 200 through transport protocol of 315 MHz, 433 MHz or Bluetooth in any one of frequency bands of 315 MHz, 433 MHz and Bluetooth.

Please refer to FIGS. 1 and 2. As shown in FIGS. 1 and 2, in an embodiment of the present invention, the input unit 104 can include a plurality of buttons including a power button 11, a trigger button 12, a direction button 13, a return button 14 and an enter button 15. The power button 11 is used to turn on/off the triple-band trigger tool. The direction button 13, the return button 14, the enter button 15 and the trigger button 12 are used to control the triple-band trigger tool. The display unit 105 can be an LCD screen.

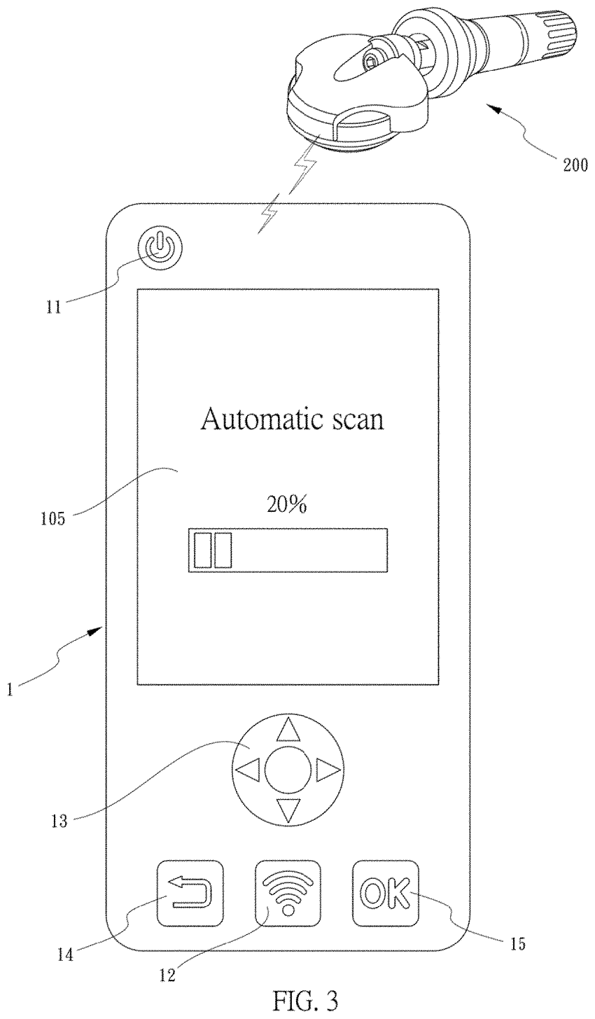

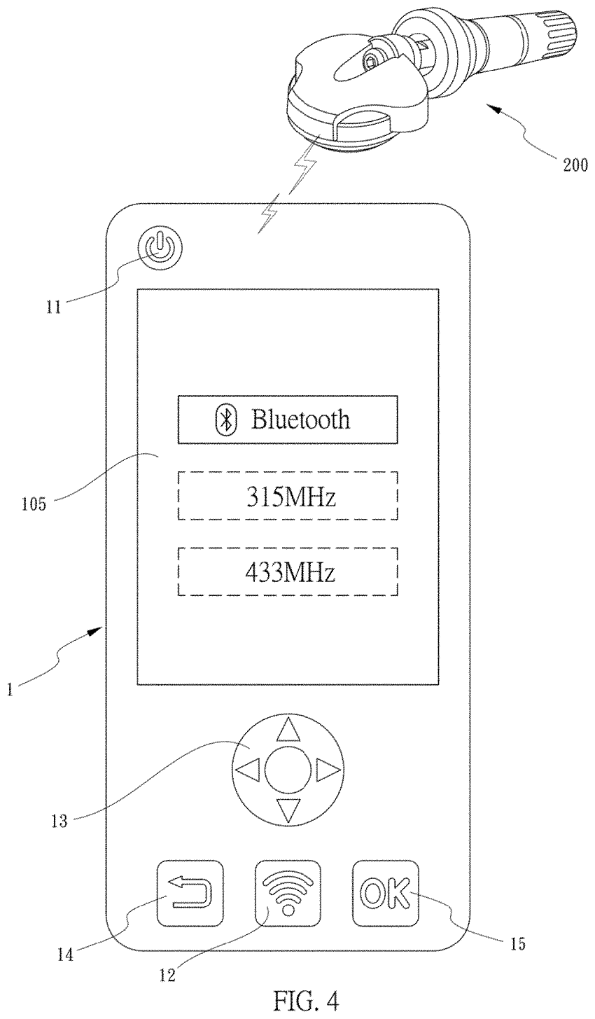

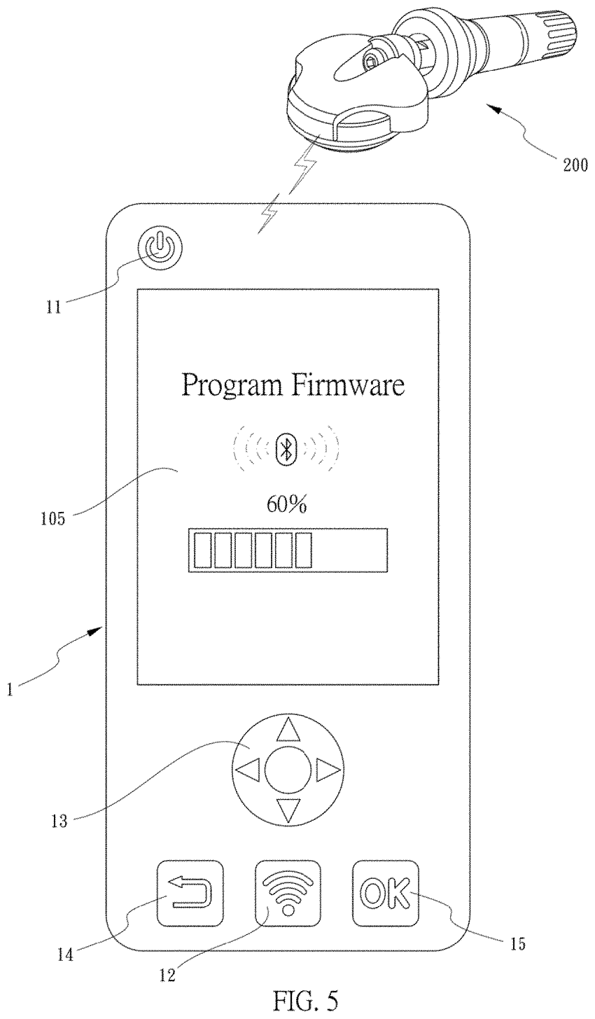

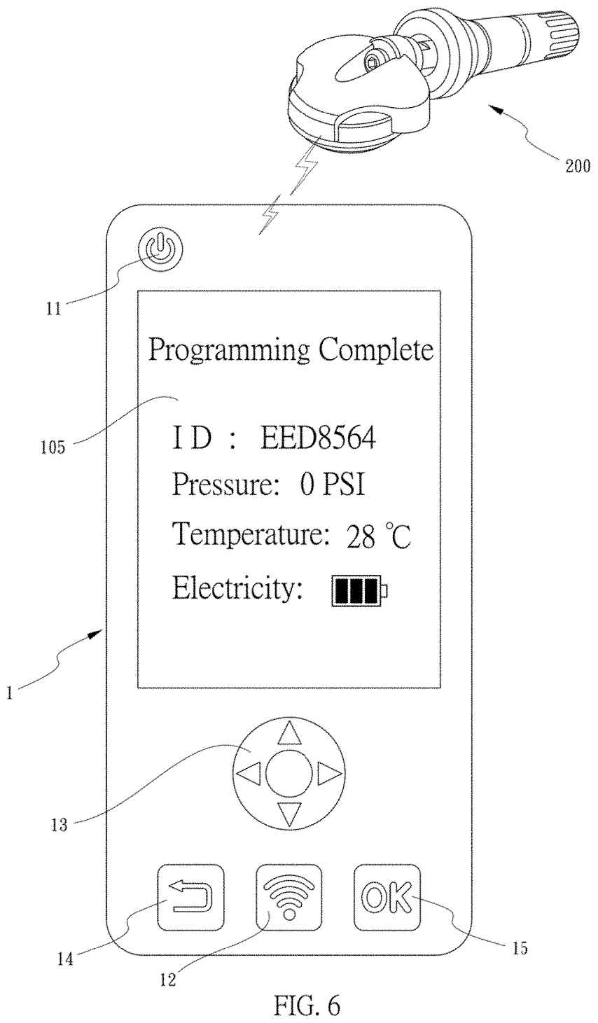

The operation of the triple-band trigger tool of the present invention is described in the following paragraphs. When the TPMS sensor is installed during vehicle manufacturing process or a repair shop replaces the TPMS, besides manual input of ID code/program, a user can move the TPMS sensor 200 close to the tool body 1 (as shown in FIG. 3) and press the trigger button 12, the tool body 1 then performs automatic scanning operation; after the display unit 105 displays the scan result as a Bluetooth frequency band among the three frequency bands including Bluetooth, 315 MHz and 433 MHz, as shown in FIG. 4, the user can press the enter button 15 to program firmware into the TPMS sensor 200 through transmission in Bluetooth frequency band, as shown in FIG. 5. After the programming operation is completed, the display unit 105 can display the temperature value, pressure value and electricity value, which are sensed by the TPMS sensor 200, in a digitization and graphics format, as shown in FIG. 6.

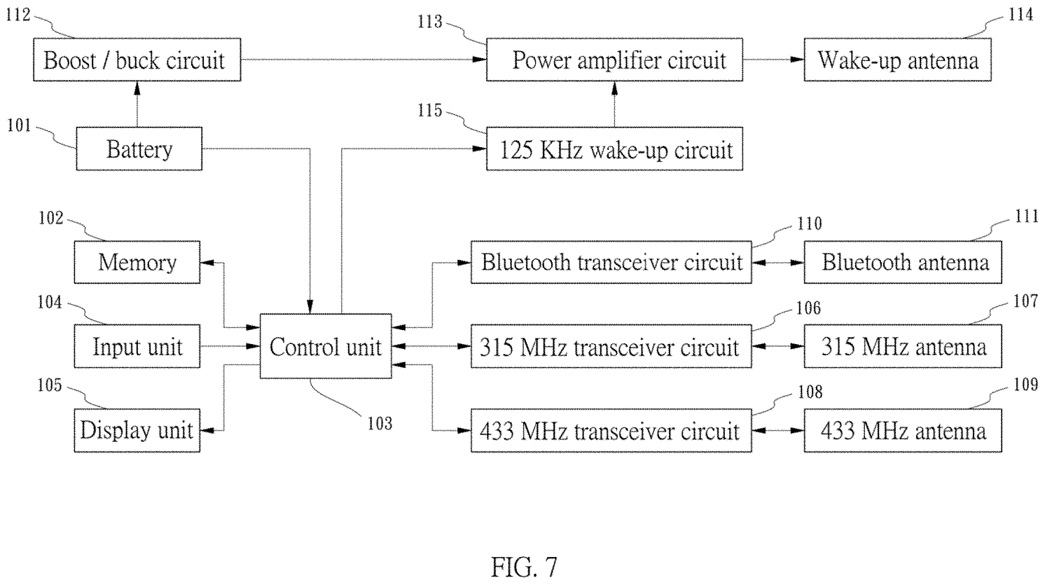

Please refer to FIG. 7. As shown in FIG. 7, the tool body 1 can include a boost/buck circuit 112, a power amplifier circuit 113, a wake-up antenna 114 and a 125 KHz wake-up circuit 115, the boost/buck circuit 112 is electrically connected between the battery 101 and the power amplifier circuit 113, the 125 KHz wake-up circuit 115 is electrically connected between the control unit 103 and the power amplifier circuit 113, and the wake-up antenna 114 is electrically connected to the power amplifier circuit 113. The triple-band trigger tool of the present invention is able to transmit a 125 KHz signal to wake up the TPMS sensor 200, so that the TPMS sensor 200 is able to output the tire temperature, the tire pressure or other information through 315 MHz, 434 MHz or Bluetooth frequency band after being woken up.

The present invention disclosed herein has been described by means of specific embodiments. However, numerous modifications, variations and enhancements can be made thereto by those skilled in the art without departing from the spirit and scope of the disclosure set forth in the claims.

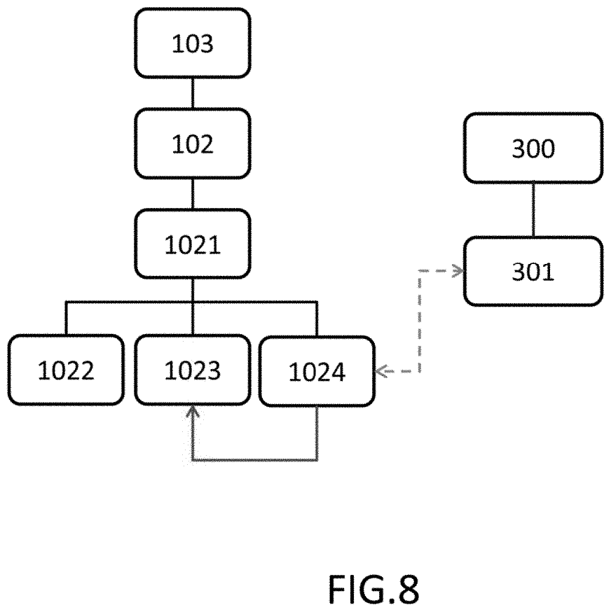

In particular, the trigger tool of the present invention can be controlled to perform firmware update operations. Referring to FIG. 8, the memory 102 stores a remote tool program 1021, the remote tool program 1021 includes an update program 1022, an operation area 1023 and a temporary storage area 1024, and the operation area 1023 stores the original firmware. when executing the update program 1022 of the remote tool program 1021, the trigger tool wirelessly receives a firmware program 301 from an external tool 300 and stores it in the temporary storage area 1024 (by the dotted double arrow in the figure). After the storage process is completed, the trigger tool restarts and overwrites the firmware program in the original firmware of the operation area 1024.

After the aforementioned update operation, the problems of the trigger tool can be fixed to function normally.

In addition, the firmware program 301 further includes the tire pressure detector driver firmware of different brands, so that the trigger tool can program the firmware action for the new model TPMS sensor 200 of each brand from the original blank state.

In addition, the original firmware and the firmware program 301 each have an identification code. The control unit 103 identifies the identification codes of the original firmware and the firmware program during the update program, when the identification codes are matched, the trigger tool restarts and overwrites the firmware program in the original firmware of the operation area; and when the identification codes are not matched, the trigger tool does not restart and overwrite the firmware program in the original firmware of the operation area.

By the identification of the above technical features, inappropriate firmware updates of the trigger tool can be avoided, which may prevent the trigger tool to crash and fail to operate.

Further, the trigger tool wirelessly receives a firmware program from an external tool 300 by Bluetooth, Wi-Fi, 4G (The fourth generation of mobile phone mobile communication technology standards) or 5G (5th Generation Mobile Networks). So that the firmware program 301 can be transmitted from the external tool 300 to the temporary storage area 1024 of the trigger tool.

What is claimed is:

1. A triple-band trigger tool for a tire-pressure monitoring system, comprising:
a tool body comprising a battery, a memory, a control unit, an input unit, and a display unit, wherein each of the battery, the memory, the input unit, and the display unit is electrically connected to the control unit;
wherein the tool body comprises a 315 MHz transceiver circuit, a 315 MHz antenna, a 433 MHz transceiver circuit, a 433 MHz antenna, a Bluetooth transceiver circuit and a Bluetooth antenna, the 315 MHz transceiver circuit and the 315 MHz antenna are electrically connected to each other, and the 315 MHz transceiver circuit is electrically connected to the control unit, the 433 MHz transceiver circuit and the 433 MHz antenna are electrically connected to each other, and the 433 MHz transceiver circuit is electrically connected to the control unit, the Bluetooth transceiver circuit and the Bluetooth antenna are electrically connected to each other, and the Bluetooth transceiver circuit is electrically connected to the control unit;
wherein the memory stores a remote tool program, the remote tool program includes an update program, an operation area and a temporary storage area, and the operation area stores the original firmware; when executing the update program of the remote tool program, the trigger tool wirelessly receives a firmware program from an external tool and stores it in the temporary storage area; after the storage is completed, the trigger tool restarts and overwrites the firmware program in the original firmware of the operation area.

2. The triple-band trigger tool according to claim 1, wherein the tool body comprises a boost/buck circuit, a power amplifier circuit, a wake-up antenna and a 125 KHz wake-up circuit, and the boost/buck circuit is electrically connected between the battery and the power amplifier circuit, the 125 KHz wake-up circuit is electrically connected between the control unit and the power amplifier circuit, and the wake-up antenna is electrically connected to the power amplifier circuit.

3. The triple-band trigger tool according to claim 2, wherein the input unit comprises a plurality of buttons.

4. The triple-band trigger tool according to claim 3, wherein the plurality of buttons comprise a power button, a trigger button, a direction button, a return button and an enter button.

5. The triple-band trigger tool according to claim 1, wherein the display unit is an LCD screen.

6. The triple-band trigger tool according to claim 1, wherein the original firmware and the firmware program each have an identification code; the control unit identifies the identification codes of the original firmware and the firmware program during the update program, when the identification codes are matched, the trigger tool restarts and overwrites the firmware program in the original firmware of the operation area; and when the identification codes are not matched, the trigger tool does not restart and overwrite the firmware program in the original firmware of the operation area.

7. The triple-band trigger tool according to claim 1, wherein the trigger tool wirelessly receives a firmware program from an external tool by Bluetooth, Wi-Fi, 4G or 5G.
